(19) United States
(12) Patent Application Publication
(10) Pub. No.: US 2006/0203783 A1
(43) Pub. Date: Sep. 14, 2006

(54) Device for delivering an aromatic substance or fragrance

(76) Inventors: Arno Gahler, Schmitten (DE); Stephan Groitzsch, Weinheim (DE); Martin Griesser, Eschborn (DE); Stephan Stolzl, Weinheim (DE); Sebastian Joussen, Seeheim-Jugenheim (DE)

Correspondence Address: CONTINENTAL TEVES, INC., ONE CONTINENTAL DRIVE, AUBURN HILLLS, MI, 48326-1581, US

(21) Appl. No.: 10/563,403

(22) PCT Filed: Jun. 30, 2004
(86) PCT No.: PCT/EP04/51300

§ 371 Date: Jan. 4, 2006

(30) Foreign Application Priority Data
Jul. 4, 2003 (DE) 103303928
Nov. 10, 2003 (DE) 103528555

(51) Int. Cl. H04Q 7/24

(52) U.S. Cl. 370/338

(57) ABSTRACT

Wireless communication using a telemetric device (4 . . . 7) is carried out by a control device (1), in particular in a motor vehicle (2). The control device has an interface (8) for activating and/or extending and/or modifying software modules or components of a software module by an external device (3). The modules are stored in a memory of the control device. As a result, software extensions and adaptations can be carried out in an especially simple manner.

### BACKGROUND OF THE INVENTION

The present invention relates to a control device in a motor vehicle, having an interface for activating and/or extending and/or modifying software modules or components of a software module by way of an external device. The modules are stored within a memory of the control device.

A communication interface between the control devices and the outside world is necessary for the purpose of programming, coding, testing, calibrating sensors, error diagnosis, etc. of electronic control devices in a vehicle.

Communication interfaces are known which employ a wire-connected communication for this purpose.

In this arrangement, the vehicle network is connected to an external unit (production or service tool) by way of a so-called diagnosis plug and a cable during the production or in the workshop, the external unit transmitting data to the individual control devices and receiving data from the control device.

### SUMMARY OF THE INVENTION

An object of the invention is to improve the communication between the control devices of a vehicle and an external device.

According to the invention, this object is achieved by a control device in a motor vehicle, having an interface for activating and/or extending and/or modifying software modules or components of a software module by way of an external device. The modules are stored within a memory of the control device.

According to the method of the invention which can be implemented by way of the claimed arrangement, the external device and the control device, it is possible to perform an activation and/or extension and/or modification of software modules or components of a software module. This fact allows achieving e.g. an improvement of functions, extension of functions and function release of software. In addition, new software functions can be transferred into the control device. It is, however, also possible to transmit status information about the existing control device (e.g. OES status; Original Equipment Supplier). Thus, it is among others possible that the end user of a software can procure the corresponding ‘software product’ directly from the manufacturer without having to use the indirect way via the workshop.

Wireless communication instead of a wire-connected communication is employed to transmit the information. Wireless communication requires a transmitting/receiving unit in the vehicle which is connected directly or indirectly to the control device, e.g. by way of an interface to the vehicle network (bus system), and an additional transmitting/receiving unit which is connected to an external device (e.g. production or service tool).

The wireless access to the vehicle network renders it possible to communicate with all control devices linked in the network, without needing any wiring between the vehicle and the outside world.

This approach allows a time-saving, wear-free (diagnosis plug) access to the control devices, which can be used in the following situations:

To begin with, the wireless access to the control device renders it possible to transmit information during the vehicle production. This obviates the need for the otherwise typical connection between the vehicle and a ‘production or service tool’ by way of a data cable. Further, data transfer can be executed for the first time in a particularly simple fashion even when several production steps are carried out. This will be advantageous especially in programming (‘flashing’), coding (e.g. adaptation to a vehicle variant), compatibility management (hardware and software), following, recording and analyzing operations (tracking) and for testing the control devices, and in the calibration of connected sensors and actuators.

In addition, the wireless control device access allows an error diagnosis (e.g. ‘on-board’ diagnosis), coding (e.g. activation of additional functions) when the vehicle is in a workshop. Updates or additional functions (updates) of software can then be fed into the corresponding control devices.

As this occurs, it is suitable that the method for wireless communication is so configured that it is appropriate for a communication covering distances of more than roughly 5 km. This fact achieves a wireless access to a control device over large distances, what is not attached to a certain place to a very large degree. It is this way possible to realize the above-mentioned updates without going to a workshop, either with or without a customer's request.

It is furthermore possible to use transmitting/receiving units (mobile telephone networks, cell phones etc.) already provided in the vehicle in order to implement the method of the invention. This means that it is principally feasible to couple the transmitting/receiving unit in the vehicle which is necessary for the purpose described above to already existing devices. Thus, a combination with the following devices in the vehicle is e.g. possible:

keyless closing device (‘keyless entry’)

direct tire pressure monitoring (radio link between sensor and receiver, TPMS)

mobile or car telephone (cell-phone).

It is preferably possible to establish a connection between the control device and an additional hardware resource (e.g. a backing storage) by way of a bus or a network. This connection is telemetrically controlled. It is especially preferred that data (e.g. downloads) being transmitted to the vehicle at a later time will be transmitted into the new resource.

The above-mentioned vehicle is preferably a motor vehicle which is equipped with at least one electronic control device such as an electronic brake control device. The motor vehicle can be a passenger vehicle or a truck.

The software module, which is modified or installed according to the invention, preferably concerns a method for detecting tire pressure loss on the basis of wheel speed information (so-called indirectly measuring tire pressure loss detection system; DDS). The software module may, however, also concern any other software functions which are implemented in control devices such as ABS (anti-lock system), TCS (traction slip control), ESP (Electronic Stability Program), and TPMS (Tire Pressure Monitoring on the basis of pressure sensors arranged in the tire).

According to a preferred embodiment of the invention, the respectively desired software module (upgrade, patch, new version, etc.) is stored on an application management data base for the users of the control devices (in particular the customers of motor vehicles) so that they can be downloaded directly as desired by the customer (download). The suppliers preferably have an interface allowing them to communicate in case of need in order for modifying the contents of the application management data base. As this occurs, especially each data transmission operation is protected against the access of third parties (monitoring, eavesdropping) by appropriate measures such as encoding.

It is suitably arranged for in the communication device that the control device or other appropriate arrangements within the motor vehicle communicate with the application management data base. As this occurs, data about the vehicle type and/or about the configuration existing in the vehicle is among others transmitted to the application management data base so that the appropriate version of the software module can be determined independently by the application management data base. Favorably, the vehicle customer only needs to convey which type of the application shall be modified. Version-related or vehicle-related inputs are not necessary in this case.

It is also possible that, instead of transmitting the software module, this module is already stored in the control device, however, is not yet activated in the beginning. The vehicle customer may then have the non-activated software module cleared telemetrically by way of communication with the application management data base or any service location.

Further preferred embodiments can be seen in the following description of the Figures.

### BRIEF DESCRIPTION OF THE DRAWING

The invention will be explained in detail in the following by making reference to an example.

In the accompanying drawing:

FIG. 1 shows a motor vehicle which can communicate with an application management data base by way of a wireless telemetry device.

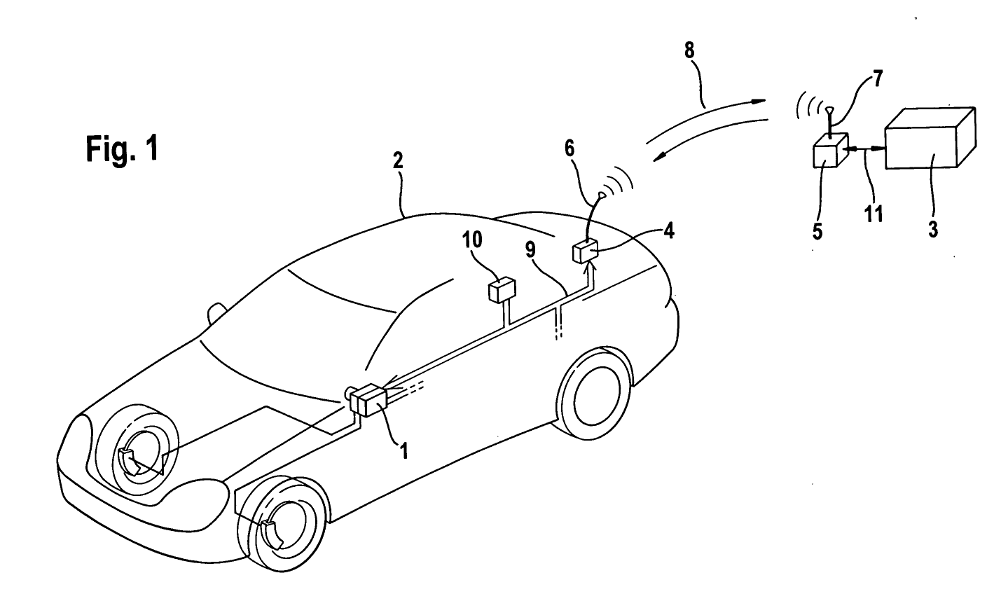

### DETAILED DESCRIPTION OF THE DRAWING

Motor vehicle 2 comprises an electronic brake control device 1 which is equipped with a microcontroller and a changeable ROM

memory (e.g. flash ROM) to perform most various controlling and regulating tasks (ABS, ESP, etc.). The control device is connected to other electronic hardware appliances 4, 10 by way of CAN bus 9. Reference numeral 4 designates a mobile radiotelephone service appliance with antenna 6 for the communication with the outside world. Memory 10 is also connected to CAN bus 9 by means of interface electronics.

Various versions and updates of tire pressure detection software are stored in the application management data base 3.

In case of need, data base 3 also comprises other software functions such as ABS, TCS, ESP, DDS, etc. Upon request of the vehicle owner or on the initiative of the vehicle maker, current versions of the software can be transmitted to the control device 1 in a wireless way over large distances. The application data base can also be used jointly by a group of companies and located centrally irrespective of who the manufacturer is. It is furthermore feasible to provide an application data base with country-specific software in every country.

1-7. (canceled)

8. A control device comprising:
one or modules stored within a memory of the control device; and
an interface (8) for activating software modules or components of a software module by way of an external device (3), wherein the interface communicates with the one or more modules in a wireless manner by means of a telemetric device.

9. The device according to claim 8, wherein transport of data during the telemetric transmission is protected by a safety device.

10. The device according to claim 8, wherein additional hardware resources are connected to the control device in a telemetrically controlled manner.

11. The device according to claim 8 further comprising:
an external device (3) in communication with the control device, the external device is connected to a transmitting and receiving unit by the interface.

12. The device according to claim 11, wherein the control device is in a motor vehicle and the vehicle includes a transmitting and receiving unit which is connected to a network by the interface.

13. The device according to claim 11, wherein the control device is in a motor vehicle and the vehicle includes a transmitting and receiving unit which is connected to a bus by the interface.

14. A control device comprising:
one or modules stored within a memory of the control device; and
an interface extending software modules or components of a software module by way of an external device, wherein the interface communicates with the one or more modules in a wireless manner by means of a telemetric device.

15. A control device comprising:
one or modules stored within a memory of the control device; and
an interface (8) for modifying software modules or components of a software module by way of an external device, wherein the interface communicates with the one or more modules in a wireless manner by means of a telemetric device.

16. A method for activating software modules or components of a software module by means of a telemetric device, the method comprising:
providing one or modules stored within a memory of the control device;
providing an interface (8) for activating software modules or components of a software module by way of an external device (3), wherein the interface communicates with the one or more modules in a wireless manner by means of a telemetric device; and
activating the software modules or components of a software module by connecting an accessory unit in range of the external device.

17. The method according to claim 16, wherein the accessory unit is a CD-ROM drive.

18. The method according to claim 16, wherein the accessory unit is a diagnosis test appliance.
